(19) United States
(12) Patent Application Publication
(10) Pub. No.: US 2019/0230941 A1
(43) Pub. Date: Aug. 1, 2019

(54) Device and process for the continuous production of dimensionally stable foamed foodstuffs

(71) Applicant: Deutsches Institut für Lebensmitteltechnik e. V., Quakenbrück (DE)

(72) Inventor: Volker Lammers, Quakenbrück (DE)

(21) Appl. No.: 16/209,346

(22) Filed: Dec. 4, 2018

(30) Foreign Application Priority Data
Dec. 6, 2017 (DE) 10 2017 222 096.1

(51) Int. Cl. A21D 8/02; A21D 13/066; A21D 13/50; A21C 1/00; A21C 1/06; A21C 1/10; A21C 11/20; A23L 7/17; A23P 30/20; A23P 30/34

(52) U.S. Cl. CPC A21D 8/025; A21D 13/066; A21D 13/50; A21C 1/006; A21C 1/065; A23V 2002/00; A21C 11/20; A23L 7/17; A23P 30/20; A23P 30/34; A21C 1/10

(57) ABSTRACT

The invention relates to a process and to a device for producing a pore-containing foodstuff, the matrix of which enclosing the pores contains starch. The process is characterized in that the dough is flowable, is admixed with pressure gas and is expanded through a nozzle into an adjacent flow-through channel so that the raw dough containing pressure gas foams in the flow-through channel. For warming of the foamed dough the flow-through channel has a section which is directly adjacent and has at least two electrodes arranged on its circumference for applying current to the foamed dough.

The present invention relates to a device and to a process that can be carried out with it for producing dimensionally stable foamed foodstuffs from a starch containing raw food mass, which is also referred to as raw dough, which is flowable, respectively pumpable, by continuous warming. The starch containing raw food mass, respectively the dough, is warmed up to a temperature at which it is stable for demoulding. The process has the advantage to produce a dimensionally stable foamed foodstuff by warming also from raw dough which prior to the warming has no sufficient stability. The dough can e.g. be a starch containing dough, respectively be a dough on the basis of starch, having a protein content, e.g. of gluten, which is too low to sustain a structure having gas bubbles in the raw dough.

### BACKGROUND

U.S. Pat. No. 6,399,130 B2 describes a process and a device for producing breadcrumbs by shaping a bread dough into a ribbon which is shaped into a wave form by conveyor belts of different speed and subsequently is conveyed through an oven which is to warm the dough by means of a radiofrequency.

WO 95/18543 A for producing foodstuffs having fibres describes the warming of a dough by means of microwaves or by application of electrical current in a pipe, the cross-section of which diminishes along the way of the flow, wherein the dough in the inner cross-section is heated stronger than adjacent to the wall of the pipe.

EP 2741616 B1 describes the warming of foodstuffs by application of current by controlled electrode segments, wherein the foodstuff can be moved between electrode segments which encircle its circumference.

WO 2017/081271 A1 describes the mixing and dissolving of one of the water-soluble gases CO₂ or N₂O in pastry dough at a pressure below critical conditions and subsequent foaming by relaxation by means of a nozzle. The obtained foamed dough is subsequently baked in baking moulds.

### SUMMARY OF THE INVENTION

Embodiments of the invention provide an alternative process for producing a pore-containing foodstuff and an alternative device suitable for performing the process. Preferably, the process is suitable to produce a pore-containing foodstuff from raw dough by warming which raw dough prior to the warming has no sufficient stability for sustaining gas bubbles, especially from raw dough which due to too low a protein content has no stability, especially for a gluten-free dough on the basis of starch.

### BRIEF DESCRIPTION OF THE DRAWINGS

The invention is now described in greater detail by way of examples with reference to the figures, which show in

FIG. 1 schematically the process and in

FIG. 2 A) and B) raw foamed dough, and in C) and D) a foodstuff produced according to the invention.

Same reference numerals designate functionally equal elements.

### DETAILED DESCRIPTION OF THE PREFERRED EMBODIMENTS

Preferred embodiments provide a process and by a device useable for the process for producing a pore-containing foodstuff the matrix of which, which contains the pores, is starch-containing. Preferably, the dough that forms the matrix has a protein content which is so low that the raw starch-containing dough has no stability sufficient for sustaining gas bubbles, especially no stability sufficient to sustain gas bubbles in their distribution and size for at least 10 minutes or for at least 5 minutes. Optionally, the protein content of the raw dough is so low that the raw dough is gluten-free and e.g. does not contain added protein either. The process is characterized in that the dough is flowable, is mixed with pressure gas and is expanded through a nozzle into an adjacent flow-through channel so that the raw dough containing the pressure gas foams in the flow-through channel. The mixing of the pressure gas occurs under pressure, preferably at 5 to 60 bar, preferably at 10 to 30 bar. The amount of pressure gas results from the desired pore fraction, e.g. 40 vol.-% to 60 vol.-% at ambient pressure. Preferably, the cross-section of the flow-through channel and the cross-section of the nozzle, optionally a conveyor device or a valve for conveying the dough through the nozzle into the flow-through channel is disposed such that the dough admixed with the pressure gas is expanded through the nozzle, respectively into the flow-through channel, with a rate of the pressure drop of at least 60 bar/min. For controlling the rate of expansion of the foamed dough upon its passing through the nozzle into the flow-through channel a conveyor device and/or a valve can be arranged in front of the nozzle in order to control the flow rate of the dough through the nozzle to a rate of at least 60 bar/min. Generally, a valve can be a pressure-sustaining valve, which preferably is controlled.

For warming the foamed dough the flow-through channel has a section which is immediately adjacent and has at least two electrodes arranged at its circumference in order to apply current to the foamed dough. The application of current to the foamed dough results in a warming of the foamed dough across the cross-section of the flow-through channel which occurs sufficiently fast for generating a stability which is sufficient for demoulding. The warming by application of current to the electrodes occurs e.g. until reaching a temperature at which the starch of the dough gelatinizes and/or up to a temperature at which the protein of the dough denatures, in order to generate the stability sufficient for demoulding. Optionally, the dough is warmed to a temperature in the range of from 72° C. to 120° C., e.g. to 90 to 100° C. Preferably, current of a power which is sufficient for warming the dough to such a temperature within at maximum 30 s to 5 min, preferably within at maximum 2 min or at maximum 1 min is applied to the electrodes. Such an electric power can e.g. be in the range of from 0.5 to 5 kW.

Preferably, the dough is moved at a speed of 0.05 to 10 m/s through the section of the flow-through channel in which the electrodes are arranged. Such a speed, which can be controlled by a conveying device for conveying the dough through the nozzle or by a valve arranged in front of the nozzle, reduces or prevents adhesions, especially to the electrodes and/or in the adjacent section of the flow-through channel.

The movement of the dough in the flow-through channel can be driven by the conveyor device which is arranged upstream of the nozzle. The conveyor device can be a pump and/or a connected pressure gas source, optionally in connection with a controlled valve.

A stability sufficient for demoulding is a stability at which the pore-containing foodstuff after cooling to 20° C. or to 5° C. remains dimensionally stable, e.g. after cooling directly subsequent to the warming, preferably for at least 2 d, e.g. in an atmosphere in which the foodstuff does not dry and preferably does not take up additional humidity. A sufficient dimensional stability is e.g. one at which the pore-containing foodstuff at 20° C. for a dimension of the foodstuff of 5×5×5 cm is indented preferably elastically, by at maximum 10%, preferably by at maximum 5% under a loading having a weight of 420 g and having a flat round contact area having a diameter of 3.5 cm.

The temperature at which the starch in a dough gelatinizes is in the range of from 50 to 90° C., preferably of from 60 to 70° C.

A starch-containing dough and the pore-containing foodstuff produced therefrom preferably has a pore content of the least 40 vol.-% to 60 vol.-%, preferably of 45 to 55 vol.-%. The dough, raw and foamed with pressure gas, can have a density of 450 to 550 kg/m³, e.g. of 500 kg/m³.

In addition to the pressure gas the dough optionally does not contain an added foaming agent. Optionally, the dough may contain yeast as a creator of taste. The pressure gas is mixed to the dough e.g. up to an overpressure of up to 60 bar, e.g. 10 to 50 bar, or 10 to 30 bar, e.g. in a mass ratio of 0.05 to 2 wt.-%, preferably of 0.5 to 1.5 wt.-% pressure gas in relation to dough. From this there results a gas volume proportion of 0.3 to 80%, e.g. from 0.8 to 30% in the product, e.g. bread dough. The pressure gas can be mixed into the raw dough by means of a mixer or in a mixer can be mixed together with the ingredients of the dough to a raw, pressure gas containing dough. The dough can be mixed from its ingredients in batches, preferably continuously.

The mixture can be an impeller type mixer, a whipping machine or a static mixer in combination with a conveyor device. The raw dough is conveyed to the nozzle by means of a conveyor device, which can be arranged upstream or downstream of the mixer. Preferably, the mixer and the conveyor device are formed by an extruder.

Optionally, the pressure of the pressure gas in the raw dough can be controlled by a pressure sustaining valve which is arranged in front of the nozzle, e.g. between a mixer for the dough or a conveyor device and the nozzle. The pressure in the raw dough is preferably sustained, especially by the nozzle and/or by the pressure sustaining valve during the mixing of the pressure gas up to the nozzle. Therein, the conveyor device and the pressure-sustaining valve can be formed by a controlled pump, which preferably is controlled in dependence from the pressure of the raw dough. Preferably, the controlled pump is a gear pump.

Optionally, the dough can be mixed continuously from its ingredients, can be mixed concurrently or subsequently continuously with pressure gas and can be conveyed directly subsequently continuously through the nozzle for foaming and be expanded in the adjacent flow-through channel and be warmed by means of the electric current introduced by way of the electrodes.

The property of the raw dough to be flowable preferably is that the raw dough after the application of, respectively mixing with the pressure gas can be moved through the nozzle and the flow-through channel by means of the conveyor device. The raw dough can, e.g. prior to admixing of the pressure gas, have a viscosity of 1 to 1000 Pas, e.g. 10 to 200 Pas or 100 to 120 Pas, preferably 101 to 103 Pas, e.g. for bread dough, measured at 30° C., preferably at a shear rate of 100/s to 10 000/s, e.g. determined using a capillary viscometer (Rheograph 2002, Göttfert Werkstoff-Prüfmaschinen GmbH, Germany).

Adjacent to the nozzle the flow-through channel can have a constant cross-section. Preferably, at least in the section in which the electrodes are arranged the cross-section has a constant cross-section up to its outlet.

The device and the process performed with it have the advantage that the warming of the foamed dough by means of the electrodes to which current is applied essentially occurs concurrently over its entire cross-section, which lies between the electrodes, and thereby a concurrent and quick solidification is achieved, which results in the formation of a stable matrix on the basis of starch, in which also the pores are stable that are formed from the gas volume. The expansion of the raw dough admixed with the pressure gas through the nozzle into the flow-through channel occurs only directly prior to the subsequent section, in which the electrodes are arranged, so that also a foamed raw dough that has no sufficient stability can be stabilized by the warming prior to collapsing, respectively essentially prior to coalescing of the gas bubbles. Accordingly, the process is also suitable for producing pore containing foodstuffs from starch-containing gluten-free dough which does not contain added protein.

A starch-containing dough can contain or consist of the following components:
30 to 60 wt.-% flour,
2 to 5 wt.-% salt,
0 to 3 wt.-% stabilizer,
preferably without foaming agent in addition to the pressure gas,
remainder water.

The flour can be cereal flour, preferably wheat flour, rye flour, in each case optionally the gluten-free starch fraction thereof, and/or gluten-free starch, e.g. rice flour, buckwheat flour, potato starch, corn flour, corn starch, or a mixture of at least two of these.

The pressure gas can be CO₂, N₂ and/or N₂O.

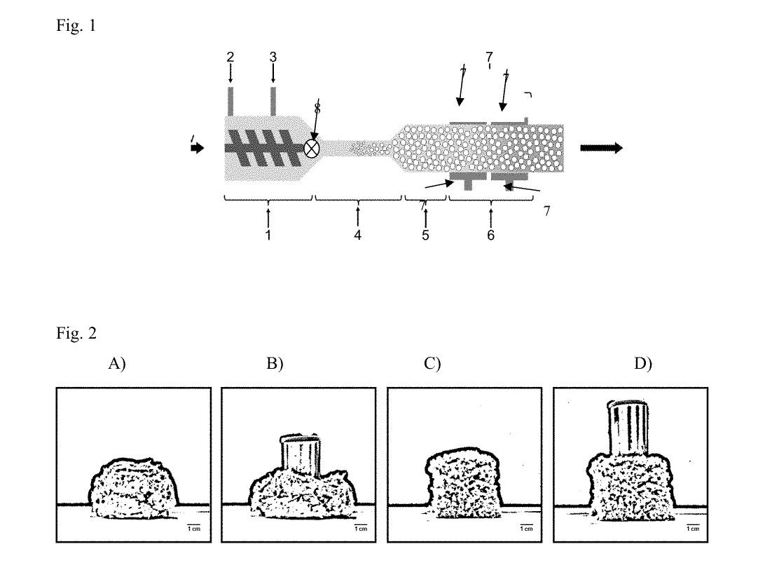

In FIG. 1, the mixer for the dough and a conveyor device are formed by an extruder 1, which has at least one inlet 2 for the components of the dough and an inlet 3 for feeding of pressure gas, which is connected to a pressure gas source. The flow direction of the dough is indicated by the arrows. The extruder 1 mixes the components of the dough to a flowable dough and mixes the pressure gas into the dough. The dough containing the pressure gas is conveyed by the extruder 1 into the nozzle 4 which is directly connected to the extruder outlet. The nozzle 4 is directly connected to the flow-through channel 5, which has a larger cross-section than the nozzle 4 and into which the dough containing pressure gas expands and foams. The flow-through channel 5 in an immediately adjacent section 6 has electrodes 7, spaced from one another, to which current is applied in order to warm the foamed dough up to a temperature at which the starch and/or the protein of the dough reach a stability sufficient for demoulding. Generally, the flow-through channel 5 adjacent to the nozzle 4 can have a round cross-section and can have a round or angular, e.g. rectangular cross-section in the section in which the spaced electrodes 7 are arranged, to which current of opposite polarity is applied. A pressure-sustaining valve 8, which is arranged between the nozzle 4 and the mixer, can be set up to sustain the pressure in the mixer, respectively in the conveyor device and/or can be set up to control the speed of the dough into the nozzle 4 and with it the pressure drop along the nozzle 4.

### Example 1: Production of a Pore-Containing Foodstuff on the Basis of Flour

As an example for a pore-containing foodstuff, bread was produced from a gluten-free baking mix on the basis of wheat starch. The baking mix did not contain added protein and no foaming agent, and as a difference to the instructions for use, no yeast was added. The baking mix was mixed with the same mass of water to a dough at 20° C. in a mixer for 2 min. Immediately subsequently, in a container the dough was mixed with an amount of CO₂ as pressure gas which at 20° C. had the same volume as the dough, and subsequently was conveyed by means of a pump through a nozzle into a flow-through channel having a constant cross-section, the cross-section of which of 56 cm² being larger by a factor of approximately 280 than the cross-section of 0.2 cm² of the nozzle. Directly subsequent to the nozzle, stainless steel electrodes were arranged on opposite inner faces of the rectangular flow-through channel to which alternating current of 1.5 kW was applied. The foamed dough was warmed between the electrodes within ca. 90 s to ca. 80° C. The electric power was adjusted to result in a warming rate of ca. 20 to 60° C./min.

After the warming the pore-containing foodstuff was sufficiently stable for demoulding and showed stability also during a subsequent storage, especially an even distribution of pores across the cross-section of the dough matrix. The pores had sizes in the range of 150 to 4000 μm and therefore corresponded to pores in common white bread.

### Example 2: Production of a Pore-Containing Foodstuff on the Basis of Flour

As an example for a pore-containing foodstuff bread of a dough, which was produced and foamed with CO₂ as pressure gas as in Example 1 was warmed to 100° C. in 180 s by application of current of a power of 1.5 kW. The foodstuff produced this way was allowed to cool to 20° C. and was cut to a cube of 5×5×5 cm edge length. The dimensional stability was determined by loading of the cube-shaped foodstuff by a cylindrical weight of 420 g with its flat end face (3.5 cm diameter). This weight indented the foodstuff by approximately 5% of its height, measured as the movement of the weight from the unloaded contact of the upper surface of the foodstuff to the standstill of the sinking movement, which indicates a sufficient dimensional stability of the foodstuff.

FIG. 3 in A) shows that the foamed raw dough 10, which was removed from the flow-through channel after the expansion through the nozzle, without loading is not dimensionally stable at 20° C. In B) it is shown that the same foamed raw dough 10 under the loading by the 420 g weight is not dimensionally stable but spreads and allows the weight 11 to sink in. In FIG. 3 C) the foodstuff 12, cut approximately into a cube-shape, is shown without loading, in D) under the loading by the 420 g weight laid on top. The Figures C) and D) show that the foodstuff produced according to the invention has a sufficient dimensional stability.

1. Process for producing a foodstuff containing pores which has a starch-containing matrix around the pores, by producing a gas-containing starch-containing raw dough and warming of the raw dough, characterized in that the raw dough is flowable and is mixed with pressure gas and is expanded through a nozzle (4) into a directly adjacent flow-through channel (5) and for warming is contacted and current is applied by at least two electrodes (7) arranged at the circumference of the flow-through channel (5) in an adjacent section of the flow-through channel (5), until the dough reaches at least a temperature at which it is stable for demoulding out of the flow-through channel (5).

2. Process according to claim 1, characterized in that the raw dough is produced continuously by mixing of its components.

3. Process according to claim 1, characterized in that the raw dough is produced batch-wise by mixing of its components.

4. Process according to claim 1, characterized in that the dough is gluten-free, the starch-basis is the gluten-free starch fraction of rye flour, the gluten-free starch fraction of wheat flour, buckwheat flour, rice flour, corn flour or a mixture of at least two of these, and the dough does not contain added protein.

5. Process according to claim 1, characterized in that the components of the raw dough are mixed together with the pressure gas.

6. Process according to claim 1, characterized in that the components of the raw dough are mixed and the pressure gas is subsequently mixed into the raw dough.

7. Process according to claim 1, characterized in that the cross-section of the flow-through channel (5) is constant.

8. Process according to claim 1, characterized in that the cross-section of the flow-through channel (5) is larger by a factor of 100 to 200 than the cross-section of the nozzle (4).

9. Process according to claim 1, characterized in that the pressure gas is sustained in the raw dough prior to passing through the nozzle (4) by a pressure-sustaining valve (8) which is arranged between the conveyor device and the nozzle (4).

10. Process according to claim 1, characterized in that the pressure gas is mixed into the raw dough up to an overpressure of 10 to 60 bar.

11. Process according to claim 1, characterized in that the nozzle (4) is set up for a pressure drop of at least 60 bar/min in the flow-through channel (5).

12. Process according to claim 1, characterized in that for the dough mixed with the pressure gas the rate of the pressure drop through the nozzle and/or the speed of the dough through the section of the flow-through channel, in which the electrodes are arranged, is controlled by a conveyor device and/or by a valve (8) arranged in front of the nozzle.

13. Process according to claim 1, characterized in that the temperature at which the dough is stable for demoulding out of the flow-through channel (5) is the gelatinizing temperature of the starch.

14. Process according to claim 1, characterized in that steam exits through outlet openings in the wall of the flow-through channel (5) in a section of the flow-through channel (5) that lies downstream from the electrodes (7).

15. Device for use in a process according to claim 1 for producing a porous foodstuff having a starch containing matrix around the pores, having a dough mixer (1) and a device for continuous warming of a dough, characterized by a mixer (1) which is arranged for mixing of pressure gas into a dough and by a conveyor device which is arranged to convey the dough mixed with the pressure gas through a nozzle (4) connected to the conveyor device, to which nozzle (4) a flow-through channel (5) is directly adjacent, the flow-through channel (5) having a cross-section into which the dough mixed with the pressure gas expands, wherein the device for continuous warming is an adjacent section of the flow-through channel (5) in which at least two electrodes, to which current is applied, are arranged on the circumference of the flow-through channel (5).

16. Device according to claim 15, characterized in that the mixer and the conveyor device are formed by an extruder (1), to which a pressure gas source is connected.

17. Device according to claim 15, characterized in that a pressure-sustaining valve (8) is arranged between the conveyor device and the nozzle (4).

18. Device according to claim 15, characterized in that the electrodes (7) are connected to a current source having a power which is sufficient for warming the dough within at maximum 5 min to a temperature in the range of from 72° C. to 120° C.
